(19) United States
(12) Patent Application Publication
(10) Pub. No.: US 2026/0224444 A1
(43) Pub. Date: Aug. 6, 2026

(54) ADAPTOR FOR USE IN A FLUID TRANSFER SYSTEM

(71) Applicant: EQUASHIELD MEDICAL LTD, Migdal Tefen (IL)

(72) Inventors: Eric SHEM-TOV, Ramat Hasharon (IL); Marino KRIHELI, Savion (IL); Raanan TAVOR, Yuvalim (IL)

(21) Appl. No.: 19/148,185

(22) PCT Filed: Jan. 31, 2024
(86) PCT No.: PCT/IL2024/050119

§ 371 Date: Jul. 15, 2025

Related U.S. Application Data
(60) Provisional application No. 63/482,644, filed on Feb. 1, 2023.

(51) Int. Cl. A61J 1/20

(52) U.S. Cl. CPC A61J 1/2096; A61J 1/2055

(57) ABSTRACT

Some embodiments are directed towards an adaptor configured to be connected to a first container of a fluid transfer system and to facilitate fluid communication between the first container and a second container of the fluid transfer system. The adaptor can include a proximal body portion; and a distal body portion extending distally from the proximal body portion at least partially along a longitudinal axis of the adaptor. The distal body portion can include a plurality of circumferential elements, each extending distally with respect to the proximal body portion, each of the plurality of circumferential elements comprising a respective bridge portion; and a plurality of connection elements each connecting the bridge portions of corresponding two adjacent circumferential elements of the plurality of circumferential elements. Each of the connection elements can be configured to radially displace between a normal state and an expanded state.

### CROSS-REFERENCE TO RELATED APPLICATIONS

This application is a national phase filing under 35 C.F.R. § 371 of and claims priority to PCT Patent Application No. PCT/IL2024/050119, filed on Jan. 31, 2024, which claims the priority benefit under 35 U.S.C. § 119 of U.S. Provisional Patent Application No. 63/482,644, filed on Feb. 1, 2023, the contents of which are hereby incorporated in their entireties by reference.

### TECHNICAL FIELD

The presently disclosed subject matter relates to the field of fluid transfer devices, and more particularly to an adaptor for connecting to a container of a fluid transfer system and facilitating fluid transfer.

### BACKGROUND

Adaptors are generally connected to a container to facilitate transfer of fluid between the container and another container. For instance, in a fluid transfer system, a first container contains a volume of fluid that is to be transferred to one or more second containers, and an adaptor is connected to the first container for facilitating the transfer of fluid. The adaptor is required to be connected strongly enough so that the adaptor does not get disconnected from the container during use, for example, by unintentional forces. Moreover, this strong connection is required to be achieved not at the expense of compact size, shape and design of the adaptor.

### GENERAL DESCRIPTION

The presently disclosed subject matter relates to an adaptor for connecting to a first container of a fluid transfer system and to facilitate fluid communication with a second container of the fluid transfer system. More particularly, in the field of medical drug transfers, drugs and/or dilutants are contained in containers, such as vials and/or IV bags and need to be transferred into different containers, for example by syringes and/or other IV bags, for mixing with other drugs in liquid, or solid form, with diluting liquids and/or for delivery to a patient. It is generally preferred, specifically in environments dealing with hazardous drugs, to connect the syringe and/or the IV bag to the vial and/or the other IV bag via an adaptor. The connection between the adaptor according to the presently disclosed subject matter and the first container is secure, and disconnections because of twisting/turning of the first container with respect to the adaptor, are prevented. The adaptor has a plurality of connection elements that are configured to displace in a radial direction and not in an axial direction, thereby preventing twisting and/or turning of the connection elements and thus preventing the disconnection from the first container.

Therefore, according to a first aspect of the presently disclosed subject matter there is provided an adaptor configured to be connected to a first container of a fluid transfer system and to facilitate fluid communication therethrough between the first container and a second container of the fluid transfer system, said adaptor comprising: a proximal body portion; and a distal body portion extending distally from the proximal body portion at least partially along a longitudinal axis of the adaptor, said distal body portion comprising: a plurality of circumferential elements each extending distally with respect to the proximal body portion, each of the plurality of circumferential elements comprising a respective bridge portion; and a plurality of connection elements each connecting the bridge portions of corresponding two adjacent circumferential elements of the plurality of circumferential elements, each of the plurality of connection elements being configured to radially displace between a normal state and an expanded state in a connection plane perpendicular to the longitudinal axis for facilitating the connection of the adaptor to the first container in the connection plane. In some examples, the bridge portions can also lie at least partially in the connection plane.

It is to be understood herein that the first container can be any container including a vial, an IV bag, syringe, elastomeric pump, bottle, ampule, or generally any vessel or receptacle suitable for holding fluids or liquids or solids, having a head portion configured to be connected to the adaptor according to the presently disclosed subject matter. Any description herein referring to a vial as a first container is to be understood as analogously applying to other examples of the first containers as well.

Also, the second container can be any fluid transfer component including a syringe, a pump mechanism, a tubing set, etc., configured for transfer of fluid to and/or from the first container, and any description herein referring to a syringe as a first container is to be understood as analogously applying to other examples of the second containers as well.

As referred to herein, fluid typically comprises a drug, a diluent, saline solution, water or any other fluid used for pharmaceutical preparation. The terms “pharmaceutical” and “drug” are used interchangeably.

The terms proximal and distal are to be understood herein as being used with respect to a user. For instance, the proximal body portion is closer to the user than the distal body portion when the adaptor is held by the user for connection to the first container. In other words, the distal body portion is closer to the first container than the proximal body portion. Thus, the distal body portion extending distally from the proximal body portion is to be understood as extending towards the first container. The proximal body portion can have a disk-shaped bottom and an elongated stem extending proximally therefrom and having a septum positioned at a top end thereof for receiving therethrough a needle of a syringe. The adaptor can have a spike extending distally from the disk-shaped bottom and configured to pierce into a septum of the first container during connection of the adaptor and the first container. The spike can have a liquid channel for transfer of liquid and an air channel for transfer of air. A needle of a syringe (or a tubing set, generally constituting a fluid transfer component) can be positioned in the spike for transfer of fluid (and/or air) to or from the first container. It should be understood herein that the spike and/or the proximal body portion can have any shape and structure suited for the operations thereof. In some examples, the proximal and distal body portions can be manufactured as separate elements that can be joined together, and in some examples, the proximal and distal body portions can be integrally formed with each other as a single element.

It is to be understood herein that the adaptor can have any number of circumferential elements for the purposes of required strength of the connections, and correspondingly connection elements between all or some of the circumferential elements.

In some examples, each of the connection elements can comprise a connection surface extending in the connection plane and configured to engage a corresponding engagement portion of the first container. The connection surface can be configured to extend within the connection plane at the normal state as well as the expanded state of the connection element. For instance, the connections elements can displace in a radial direction (a direction perpendicular to the longitudinal axis) and not in the axial direction (a direction parallel to the longitudinal axis). In fact, no component of the displacement of the connection elements may lie in the axial direction. In some examples, the connection surface can have an innermost portion closest to the longitudinal axis, whereas the connection elements can displace between the normal and expanded state, such that the innermost portion can be at a first distance from the longitudinal axis, at the normal state of the corresponding connection elements, and at a second distance greater than the first distance, at the expanded state of the corresponding connection element. The innermost portions of the connection surfaces can define portions of a virtual circle extending in the connection plane, wherein the virtual circle has a first diameter at the normal state of the connection elements and a second diameter greater than the first diameter at the expanded state of the connection elements.

In some examples, the connection elements can be configured to radially displace from the expanded state to the normal state, elastically. For instance, the connection elements can be configured to radially displace from the expanded state to the normal state upon application of a force, and to return automatically to the normal state upon removal of the force. In some examples, the force can be an axial force applied on the connection elements in a direction from the distal body portion to the proximal body portion along the longitudinal axis, for example by the first container during the connection of the adaptor to the first container.

Each of the connection elements can have at least one reformable portion configured to reform for facilitating the displacement of the connection elements between the normal state and the expanded state. The reformable portions can constitute any suitable shape configured to be changed upon application of force for facilitating expansion of the connection elements and retraction thereof into their original shape upon removal of the force. The reformable portions can be positioned along the connection elements according to various implementations and examples. In some examples, the reformable portions can have a generally bent shape associated with the normal state of the respective connection elements, and generally comparatively stretched and straightened shape associated with the expanded state of the respective connection elements. Upon application of a force thereon, the reformable portion can change its shape from the bent shape to the comparatively straightened shape thereby displacing the respective connection element into the expanded state. The reformable portions can reform their shape from the bent shape to the comparatively straightened shape elastically, i.e., upon removal of the force, the reformable portion can elastically return to the bent shape thereby elastically displacing the respective connection element into the normal state. In some examples, the reformable portions can be implemented with any shape suitable for the described operation of the connection elements. In some examples, each of the connection elements can have a central portion and two reformable portions connected to corresponding bridge portions. The central portion can correspond to and/or be constituted at least partially by the connection surface. For instance, the reformable portions can connect the respective connecting elements to the corresponding bridge portions. Each of the reformable portions is configured to change its shape to facilitate the displacement of the respective connection element between the normal state and the expanded state. In some examples, the number and location of the reformable portions can be selected for being suitable for the desired operation of the connection elements, including a desired extent of expansion of the connection elements.

In some examples, each of the connection elements can comprise a guiding element extending distally from the innermost portion in a direction along the longitudinal axis, as well as in a direction away from the longitudinal axis, whereas the guiding element can be configured to engage the first container during the connection of the adaptor with the first container. The guiding element can be an inclined element (formed as a single element or a plurality of elements) inclining from the innermost portion of the connection element distally and away from the longitudinal axis. The guiding element can be configured to translate an axial force applied by a head of the first container thereon in a direction from the distal body portion to the proximal body portion along the longitudinal axis to a radial force in a direction along the connection plane away from the longitudinal axis. The radial force can cause the connection elements to move away from the longitudinal axis in the connection plane, and displace into the expanded state, thereby creating a space for the head of the first container to extend beyond the connection elements. Once the head of the first container extends beyond the connection elements thereby causing the removal of the radial force, the connection elements can elastically displace into the normal state and grip a neck portion of the first container to effect the connection between the adaptor and the first container in the connection plane.

In some examples, each of the connection elements can have a respective side surface extending distally from the respective connection surface in a direction transverse thereto. The side surfaces define a height of the connection element in a direction along the longitudinal axis. The height of each of the connection elements imparts strength to the connection element to facilitate a strong connection between the adaptor and the first container. Even if it is the connection surface only that connects with the first container, the whole of the connection element, i.e., including the central portion and reformable portions, can have the height thereby imparting increased strength to the connection element against the axial/radial forces that could lead to twisting and/or pivoting of the connection element. The bridge portions can also have a height corresponding to the height of the connection element and the connection elements can be connected to the bridge portions at the entire height. Accordingly, an axial movement of the connection elements in a direction along the longitudinal axis is prevented, and/or the connection elements can be configured to prevent pivoting and/or twisting of the first container, when connected, with respect to the adaptor.

### EMBODIMENTS

A more specific description is provided in the Detailed Description whilst the following are non-limiting examples of different embodiments of the presently disclosed subject matter.
1. An adaptor configured to be connected to a first container of a fluid transfer system and to facilitate fluid communication therethrough between the first container and a second container of the fluid transfer system, said adaptor comprising:
a proximal body portion; and
a distal body portion extending distally from the proximal body portion at least partially along a longitudinal axis of the adaptor, said distal body portion comprising:
   a plurality of circumferential elements each extending distally with respect to the proximal body portion, each of the plurality of circumferential elements comprising a respective bridge portion; and
   a plurality of connection elements each connecting the bridge portions of corresponding two adjacent circumferential elements of the plurality of circumferential elements, each of the plurality of connection elements being configured to radially displace between a normal state and an expanded state in a connection plane perpendicular to the longitudinal axis for facilitating the connection of the adaptor to the first container in said connection plane.
2. The adaptor according to Embodiment 1, wherein each of the plurality of connection elements comprises a connection surface extending in the connection plane and configured to engage a corresponding engagement portion of the first container.
3. The adaptor according to Embodiment 2, wherein the connection surface extends within the connection plane at the normal state as well as the expanded state of the connection element.
4. The adaptor according to Embodiment 2 or 3, wherein the connection surface has an innermost portion closest to the longitudinal axis, said innermost portion being configured to be at a first distance from the longitudinal axis at the normal state of the corresponding connection elements and at a second distance greater than the first distance at the expanded state of the corresponding connection elements.
5. The adaptor according to Embodiment 4, wherein the innermost portions of the connection surfaces define portions of a virtual circle extending in the connection plane, wherein the virtual circle has a first diameter at the normal state of the connection elements and a second diameter greater than the first diameter at the expanded state of the connection elements.
6. The adaptor according to any one of embodiments 1 to 5, wherein the connection elements are configured to radially displace from the normal state to the expanded state in response to an axial force applied on the connection elements in a direction from the distal body portion to the proximal body portion along the longitudinal axis.
7. The adaptor according to Embodiment 6, wherein the axial force is a pushing force applied by the first container during said connection of the adaptor to the first container.
8. The adaptor according to Embodiment 6 or 7, wherein the connection elements are configured to radially displace from the expanded state to the normal state elastically upon removal of said axial force.
9 The adaptor according to any one of embodiments 1 to 8, wherein the bridge portions extend at least partially in the connection plane.
10. The adaptor according to any one of embodiments 1 to 9, wherein each of the connection elements comprises at least one reformable portion configured to reform for facilitating the displacement of the connection elements between the normal state and the expanded state.
11. The adaptor according to Embodiment 10, wherein each of the connection elements has a central portion and two reformable portions connected to corresponding bridge portions.
12. The adaptor according to Embodiment 11, when dependent on Embodiment 2, wherein the connection surface constitutes at least a part of the central portion.
13. The adaptor according to any one of embodiments 1 to 12, wherein each of the plurality of the connection elements comprises an innermost portion closest to the longitudinal axis, and a guiding element extending distally from the innermost portion in a direction along the longitudinal axis as well as in a direction away from the longitudinal axis, wherein the guiding element is configured to engage the first container during the connection of the adaptor with the first container.
14. The adaptor according to Embodiment 13, wherein the guiding element is configured to translate an axial force applied by a head of the first container thereon in a direction from the distal body portion to the proximal body portion along the longitudinal axis during said connection to a radial force in a direction along the connection plane away from the longitudinal axis.
15. The adaptor according to Embodiment 14, wherein the radial force causes the connection elements to move away from the longitudinal axis in the connection plane, and displace into the expanded state, thereby creating a space for the head of the first container to extend beyond the connection elements.
16. The adaptor according to Embodiment 15, wherein the connection elements are configured to elastically displace into the normal state once the head of the first container extends beyond the connection elements, thereby gripping a neck portion of the first container to effect the connection between the adaptor and the first container in the connection plane.
17. The adaptor according to any one of embodiments 1 to 16, wherein each of the connection elements comprise a respective side surface extending in a direction parallel to the longitudinal axis, the side surface defining a height of the connection element in the direction parallel to the longitudinal axis.
18. The adaptor according to Embodiment 17, wherein each of the bridge portions has a dimension parallel to and corresponding to the height of the connection elements.
19. The adaptor according to Embodiment 18, wherein the connection elements are connected to the respective bridge portions along whole of the height of the connection elements.
20. The adaptor according to any one of embodiments 1 to 19, wherein the connection elements are configured to prevent pivoting and/or twisting of the first container, when connected, with respect to the adaptor.
21. The adaptor according to any one of embodiments 1 to 20, wherein an axial movement of the connection elements in a direction along the longitudinal axis is prevented.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates a top perspective view of an adaptor according to an example of the presently disclosed subject matter;

FIG. 1B illustrates a bottom perspective view of the adaptor of FIG. 1A;

FIG. 1C illustrates a bottom perspective view of the adaptor of FIG. 1A with a container disconnected from the adaptor;

FIG. 1D illustrates a top perspective view of the adaptor and container of FIG. 1C during connection therewith;

FIG. 1E illustrates a top perspective view of the adaptor and container of FIG. 1C after connection therewith;

FIG. 1F illustrates a cross-sectional top view of the adaptor with the cross-section taken at line A-A of FIG. 1A;

FIG. 1G illustrates a cross-sectional perspective view of the adaptor with the cross-section taken at line B-B of FIG. 1E;

FIG. 1H illustrates a cross-sectional top view of the adaptor with the cross-section taken at line C-C of FIG. 1D;

FIG. 2A illustrates a top perspective view of an adaptor according to another example of the presently disclosed subject matter;

FIG. 2B illustrates a bottom perspective view of the adaptor of FIG. 2A;

FIG. 3A illustrates a top perspective view of an adaptor according to yet another example of the presently disclosed subject matter; and

FIG. 3B illustrates a bottom perspective view of the adaptor of FIG. 3A.

### DETAILED DESCRIPTION

The following detailed description sets forth general and specific details about features of the adaptors according to various aspects and examples of the presently disclosed subject matter.

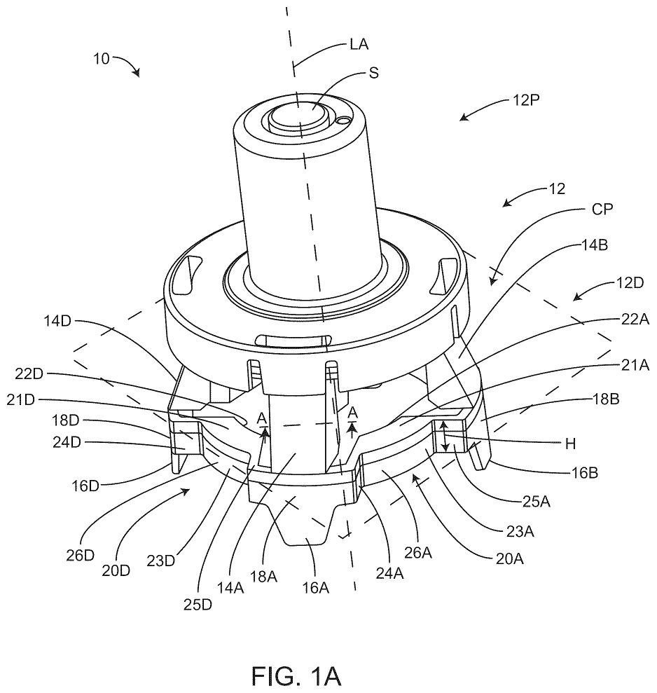

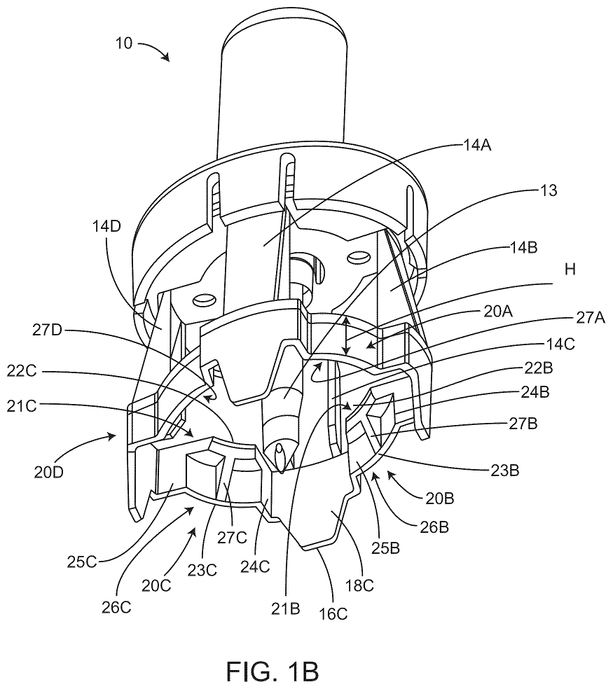

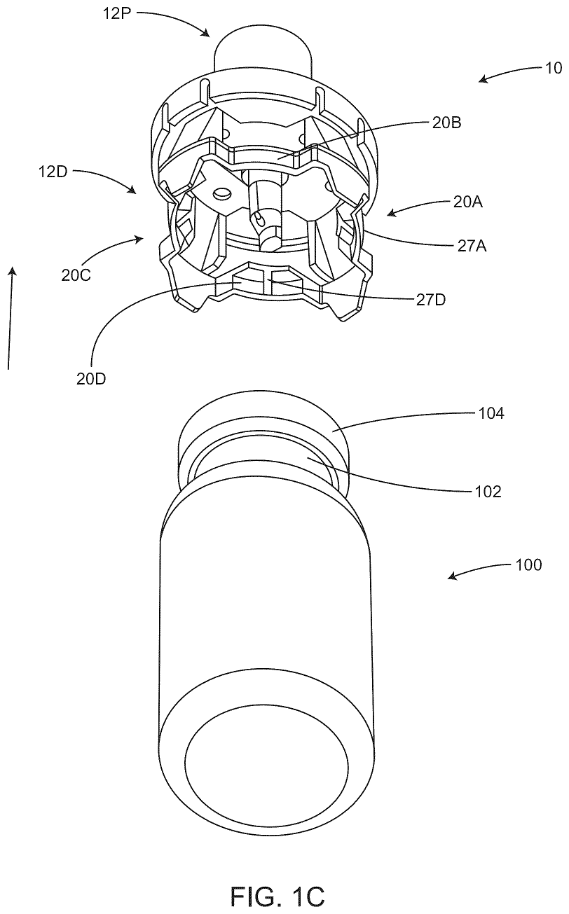

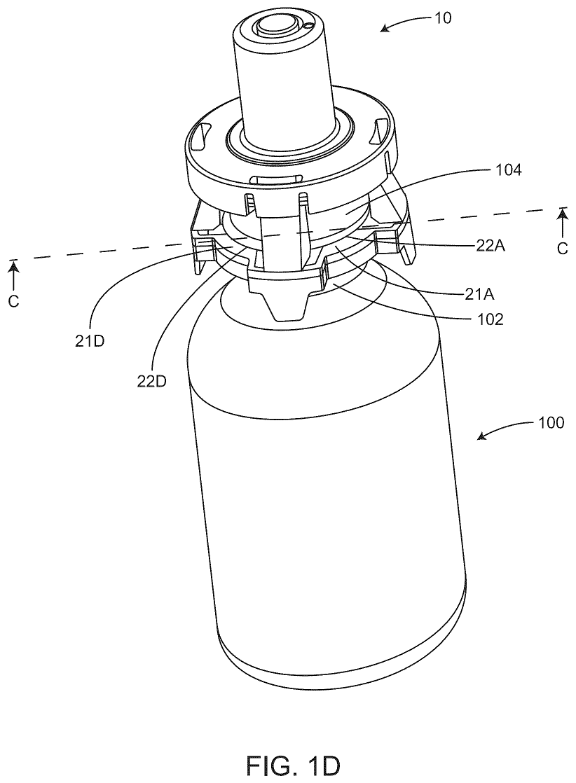

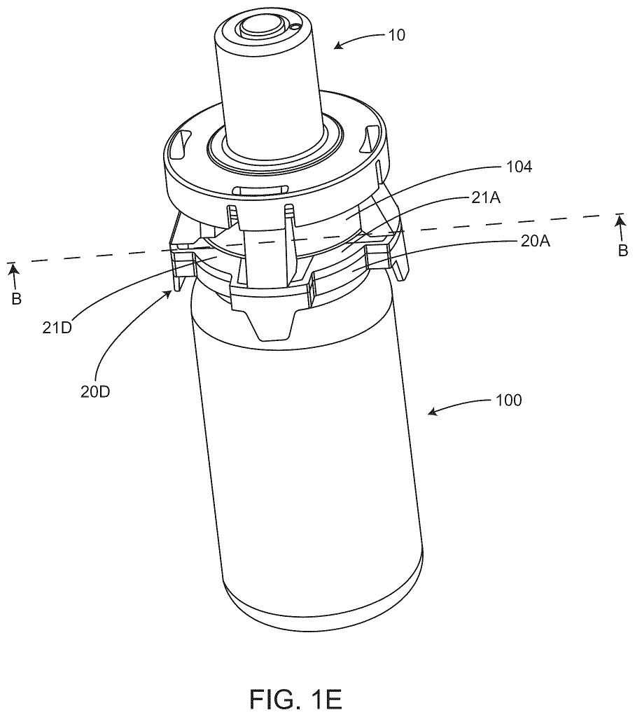

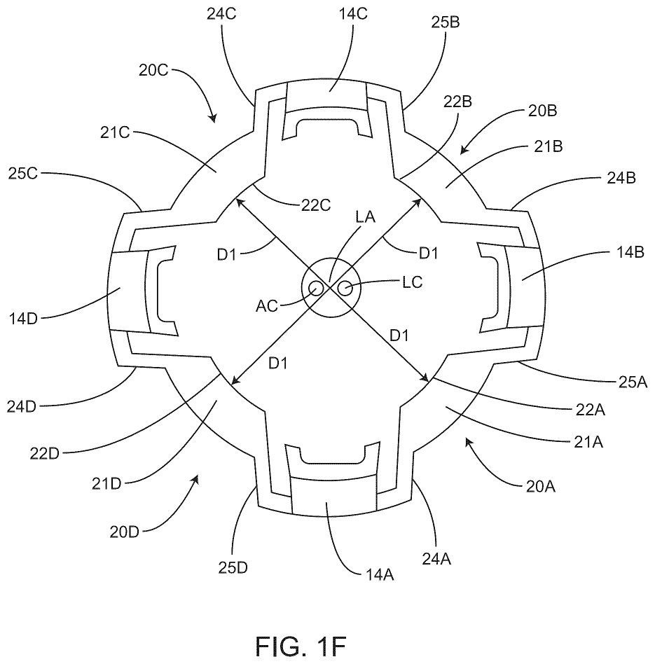

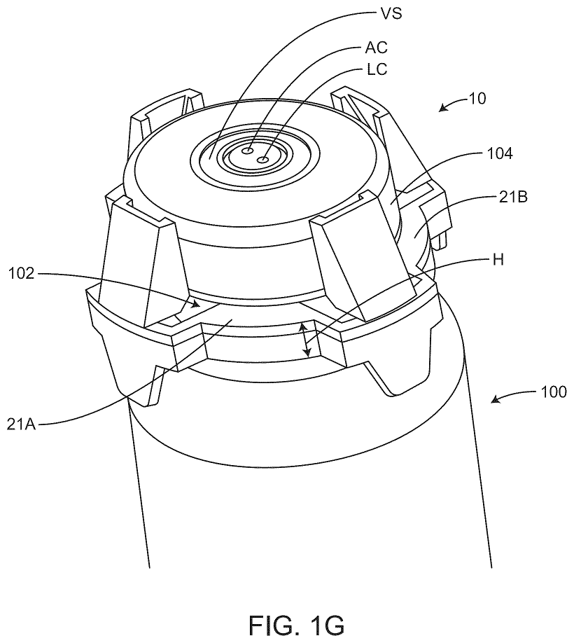

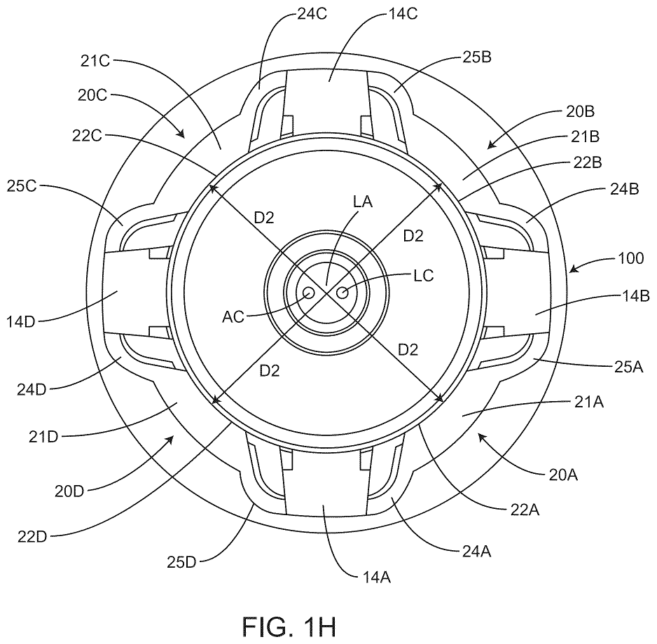

Reference is made to FIGS. 1A to 1H illustrating an adaptor 10 according to an example of the presently disclosed subject matter. The adaptor 10 is configured to be connected to a first container of a fluid transfer system and to facilitate fluid communication therethrough between the first container and a second container of the fluid transfer system. The first container can be a vial 100, generally used in medical drug transfer systems for containing drug that needs to be transferred for mixing and/or delivery. In some examples, the first container can be an IV bag or any other container having a connection portion configured for connecting to the adaptor 10. Generally, a syringe is used to transfer the drug to and from the vial 100, and thus according to an example of the presently disclosed subject matter, the second container can be a syringe. In some examples, the second container can be a pump configured to be connected to the vial via a tubing set for transfer of drug to and from the vial, thereby constituting the second container. It is to be understood herein that vial and syringe are non-limiting examples of first and second containers, and these containers can be any other containers used in medical or non-medical fluid transfer systems and configured for use with the adaptor of the presently disclosed subject matter. For the purposes of the present description, the first container has been illustrated and described as the vial 100, and hence the adaptor 10 as a vial adaptor 10, and it is to be understood herein that the first container can be any other container connectable to the adaptor of the presently disclosed subject matter.

The vial adaptor 10 has a body 12 generally extending along a longitudinal axis LA of the vial adaptor 10. The body 12 has a proximal body portion 12P and a distal body portion 12D extending distally from the proximal body portion 12P along the longitudinal axis LA. The terms proximal and distal are to be understood herein as being used with respect to a user. For instance, proximal body portion 12P is closer to the user than the distal body portion 12D when the adaptor 10 is held by the user for connection to the vial 100. In other words, the distal body portion 12D is closer to the vial 100 than the proximal body portion 12P. Thus, the distal body portion 12D extending distally from the proximal body portion 12P is to be understood as extending towards the vial 100. In the illustrated example, the proximal body portion 12P has a disk-shaped bottom and an elongated stem extending proximally therefrom and having a septum S positioned at a top end thereof for receiving therethrough a needle of the syringe. The adaptor 10 also has a spike 13 extending distally from the disk-shaped bottom and configured to pierce into a vial septum VS of the vial 100 during connection of the adaptor 10 and the vial 100. The spike 13 has a liquid channel LC for transfer of liquid and an air channel AC for transfer of air. A needle of the syringe can be positioned in the spike for transfer of fluid (and/or air) to or from the vial 100, though a needle is not required and fluid transfer may be effected in any suitable manner. The structure and functioning of the spike 13 have not been described in detail herein for the purposes of the conciseness of this description. It should be understood herein that the spike and/or the proximal body portion can have any shape and structure suited for the operations thereof, and have not been described in detail herein for the purposes of conciseness of the present description.

It is to be further understood herein that although the proximal and distal body portions 12P and 12D have been illustrated herein as separate elements that are joined together, in some examples, the proximal and distal body portions 12P and 12D can be integrally formed with each other as a single element.

The distal body portion 12D has a plurality of circumferential elements, four in the illustrated example, i.e., 14A, 14B, 14C, and 14D, each extending distally from the proximal body portion 12P towards their respective distal ends 16A, 16B, 16C, and 16D. In some examples, the adaptor 10 can have less or more than four circumferential elements. The distal ends 16A, 16B, 16C, and 16D extend distally beyond the distal most tip of the spike 13 so as to provide protection to the tip of the spike 13. Each of the circumferential elements has its respective bridge portion. For instance, the circumferential element 14A has its respective bridge portion 18A, the circumferential element 14B has its respective bridge portion 18B, the circumferential element 14C has its respective bridge portion 18C, and the circumferential element 14D has its respective bridge portion 18D.

It is to be understood herein that although in the illustrated example, the circumferential elements extend distally from the proximal portion, in some examples, the circumferential elements can be implemented as not being directly extending from the proximal portion while still being extending at least partially distally with respect to the proximal portion. In such examples, there can be a circumferential cover element extending from the proximal portion and the circumferential elements can be extending therefrom. The cover element can be a single element radially covering at least a portion of the distal body portion or a plurality of elements covering radially the distal body portion.

The bridge portions constitute that portion of the circumferential element, at which each circumferential element is connected (bridged) with its adjacent circumferential elements, by a respective connection element 20A, 20B, 20C, and 20D. For instance, the connection element 20A connects the bridge portion 18A and the bridge portion 18B, the connection element 20B connects the bridge portion 18B and the bridge portion 18C, the connection element 20C connects the bridge portion 18C and the bridge portion 18D, and the connection element 20D connects the bridge portion 18D and the bridge portion 18A. The connection elements 20A, 20B, 20C, and 20D, and consequently the corresponding bridge portions, extend in a virtual connection plane CP and are displaceable between a normal state (FIGS. 1A, 1B, 1C, 1E, 1F, and 1G) and an expanded state (FIGS. 1D and 1H) while being within the connection plane CP. The connection plane CP constitutes that plane in which the connection between the vial adaptor 10 and the vial 100 is established (FIGS. 1E and 1G), as described herein below.

Each of the connection elements 20A, 20B, 20C, and 20D has a corresponding connection surface 21A, 21B, 21C, and 21D that lies in the connection plane at both the normal state as well as the expanded state. In other words, the connections elements 20A, 20B, 20C, and 20D are displaced in the radial direction (a direction perpendicular to the longitudinal axis LA) and not in the axial direction (a direction parallel to the longitudinal axis). In fact, no component of the displacement of the connection elements lies in the axial direction. The connection surfaces 21A, 21B, 21C, and 21D engage (as can be best seen in FIGS. 1E and 1G) with a corresponding engagement portion of the vial 100, which in the illustrated example is a portion where a neck 102 of the vial 100 meets a head 104 of the vial 100, to establish the connection between the adaptor 10 and the vial 100. As can be seen in the figures, the bridge portions 18A, 18B, 18C, and 18D also extend in the connection plane CP.

Each of the connection surfaces 21A, 21B, 21C, and 21D has a respective innermost portion 22A, 22B, 22C, and 22D closest to the longitudinal axis. The innermost portions 22A, 22B, 22C, and 22D of the connection surfaces also constitute the innermost portions of the connection elements as well that lie closest to the longitudinal axis. In the illustrated example, the innermost portions 22A, 22B, 22C, and 22D have been formed as curved edges of the connection surfaces 21A, 21B, 21C, and 21D, however in some examples, the innermost portions can have other shapes suitable for engaging the first container to establish the connection between the adaptor and the first container. At the normal state of the adaptor 10 (i.e., the normal state of the connection elements), the innermost portions 22A, 22B, 22C, and 22D are at a first distance D1 (FIGS. 1F and 1G) from the longitudinal axis LA, and at the expanded state of the adaptor 10 (i.e., the expanded state of the connection elements), the innermost portions 22A, 22B, 22C, and 22D are at a second distance D2 (FIG. 1H) from the longitudinal axis LA, greater than the first distance D1. In other words, the innermost portions 22A, 22B, 22C, and 22D of the connection surfaces 21A, 21B, 21C, and 21D define portions of a virtual circle extending in the connection plane CP, and the virtual circle has a first diameter at the normal state of the connection elements 20A, 20B, 20C, and 20D (FIGS. 1F and 1G) and a second diameter greater than the first diameter at the expanded state of the connection elements 20A, 20B, 20C, and 20D (FIG. 1H).

Each of the connection elements 20A, 20B, 20C, and 20D has a respective central portion 23A, 23B, 23C, 23D, a respective first reformable portion 24A, 24B, 24C, 24D, and a respective second reformable portion 25A, 25B, 25C, and 25D (FIGS. 1A and 1B). The first and second reformable portions connect the respective connecting elements to the corresponding two bridge portions. For instance, the first reformable portion 24A of the connection element 20A connects the connection element 20A to the bridge portion 18A and the second reformable portion 25A of the connection element 20A connects the connection element 20A to the bridge portion 18B. It is to be understood herein that all the reformable portions connect their respective connection elements to the corresponding bridge portions and have not been specifically referred to and described separately herein for the purposes of conciseness of this description. Each of the reformable portions are configured to change their shape to facilitate the displacement of the respective connection elements between the normal state and the expanded state. For instance, the reformable portions have a generally bent shape associated with the normal state of the respective connection elements, and generally comparatively stretched and straightened shape associated with the expanded state of the respective connection elements. Upon application of a force thereon, the reformable portion reforms its shape from the bent shape to the comparatively straightened shape thereby displacing the respective connection element into the expanded state. It is to be understood herein that the reformable portions reform their shape from the bent shape to the comparatively straightened shape elastically, i.e., upon removal of the force, the reformable portion elastically returns to the bent shape thereby elastically displacing the respective connection element into the normal state. The illustrated shapes of the reformable portions are exemplary, and it is to be understood that the reformable portions can be implemented with any shapes suitable for the described operation of the connection elements.

Although in the illustrated example, as can be seen in the figures, each of the connection elements have been described as having a respective central portion and respective two reformable portions, it is to be understood herein that in some examples, one or more of the connection elements can have one (or even more than two) reformable portion configured to reform for facilitating the displacement of the connection elements between the normal state and the expanded state. The reformable portions can constitute any suitable shape configured to be changed upon application of force for facilitating expansion of the connection elements and retraction thereof into their original shape upon removal of the force. The reformable portions can be positioned along the connection elements according to various implementations and examples. For instance, the reformable portion can be between two non-reformable portions connected to the bridge portions and comprising the connection surfaces. In some examples, the reformable portions can include the connection surfaces, which in such examples can be reformable as well. In some examples, the number and location (along the connection element) of the reformable portions can be selected for being suitable for the desired operation of the connection elements, including a desired extent of expansion of the connection elements.

Although in the illustrated example, as can be seen in the figures, the connection surfaces constitute part of the central portions of their respective connection elements, it is to be understood that the connection surfaces can be extended up to the reformable portions. It is to be understood herein that even if the connection surfaces are extended to the reformable portions, the ability of the reformable portions to reform is maintained. The connection elements 20A, 20B, 20C, and 20D, each has a respective side surface, 26A, 26B, 26C, 26D extending distally from the respective connection surface 21A, 21B, 21C, and 21D in a direction transverse thereto. The side surfaces define a height H of the connection element in a direction along the longitudinal axis LA. The height H of each of the connection elements 20A, 20B, 20C, and 20D imparts strength to the connection element to facilitate a strong connection between the adaptor 10 and the vial 100. Although it is the connection surface only that connects with the vial, the whole of the connection element, i.e., including the central portion and reformable portions, has the height H thereby imparting increased strength to the connection element against the axial/radial forces that could lead to twisting and/or pivoting of the connection element. The bridge portions also have a height corresponding to the height H and the connection elements are connected to the bridge portions at whole of the height H. In some examples, the connection elements can be connected at only some parts along the height H to the bridge portions. However, connecting the connection elements to the bridge portions along whole of the height H significantly increases the strength of the connection elements especially against turning of the connection elements with respect to the circumferential elements thereby preventing disconnection of the first container from the adaptor. More specifically, connecting the connection elements to the bridge portions along whole of the height H prevents axial movement (along the longitudinal axis LA) of the connection elements.

It is to be understood herein that the above described structure of the connection elements and circumferential elements facilitates a strong connection between the vial and the adaptor without increasing the overall size (particularly height) of the adaptor.

Each of the connection elements 20A, 20B, 20C, 20D comprises respective guiding elements 27A, 27B, 27C, and 27D (FIG. 1B) extending distally from the corresponding innermost portions 22A, 22B, 22C, and 22D in a direction along the longitudinal axis LA as well as in a direction away from the longitudinal axis. For instance, the guiding element 27A is an inclined element inclining distally from the innermost portion 22A of the connection element 20A towards the side surface 26A. Each of the guiding elements 27A, 27B, 27C, and 27D is configured to engage the vial 100, for example head 104 of the vial 100, during the connection of the vial 100 with the vial adaptor 10, and translate an axial force applied by the head 104 on the guiding elements into a radial force for displacing the connection elements from their normal state to the expanded state.

Reference is specifically made to FIGS. 1C to 1E for describing connection of the vial adaptor 10 with the vial 100. The vial 100 is held with its head 104 towards the distal body portion 12D of the vial adaptor 10. The vial adaptor 10 is pushed towards the vial 100 and/or the vial 100 is pushed towards the vial adaptor 10 and the head 104 (for example, a rim thereof) engages the guiding elements 27A, 27B, 27C, and 27D of the connection elements 20A, 20B, 20C, and 20D, and simultaneously the spike 13 starts penetrating the vial septum VS (FIG. 1G). A further push causes the head 104 to apply an axial force (along the longitudinal axis LA) on the guiding elements 27A, 27B, 27C, and 27D in a direction extending from the distal body portion 12D to the proximal body portion 12P, illustrated by arrow F in FIG. 1C. The guiding elements 27A, 27B, 27C, and 27D being inclined with respect to the longitudinal axis LA translate the axial force into a radial force (in a direction perpendicular to the longitudinal axis LA) acting upon the connection elements 20A, 20B, 20C, and 20D. The radial force causes the reformable portions of the connection elements to deform (best seen in FIG. 1H) such that the central portions 23A, 23B, 23C, and 23D and respective connection surfaces 21A, 21B, 21C, and 21D move away from the longitudinal axis LA in the connection plane CP, thereby displacing the connection elements into their expanded states. The movement of the connection surfaces 21A, 21B, 21C, and 21D away from the longitudinal axis LA creates a space between the innermost portions 22A, 22B, 22C, and 22D large enough for the head 104 to go therethrough and beyond the connection elements 20A, 20B, 20C, and 20D. Once the entire head 104 is beyond the connection elements 20A, 20B, 20C, and 20D, and a narrower neck portion 102 of the vial 100 arrives at the connection surfaces, the radial force on the connection elements cease to exist, and thus, the connection elements elastically displace into their normal states thereby gripping (by the connection surfaces) the neck portion 102 of the vial 100 and completing the connection thereof with the adaptor 10.

As can be best seen in FIG. 1E, the dimensions of the circumferential elements 18A, 18B, 18C, and 18D and a space therebetween are so as to accommodate the head 104 of the vial adaptor 100. It is to be understood herein that the dimensions of the circumferential elements 18A, 18B, 18C, and 18D and the space therebetween can be manufactured according to the first container that it is to be connected to.

The connection elements being connected to the bridge portions on both sides and within the connection plane enables the connection elements to prevent pivoting and/or twisting of the vial 100 with respect to the adaptor 10. The fact that connection elements are connected to the bridge portions all along the height H further improves the capability of the connection elements to prevent pivoting and/or twisting of the vial 100 with respect to the adaptor 10 thereby preventing the unintentional disconnection of the vial 100 from the vial adaptor 10.

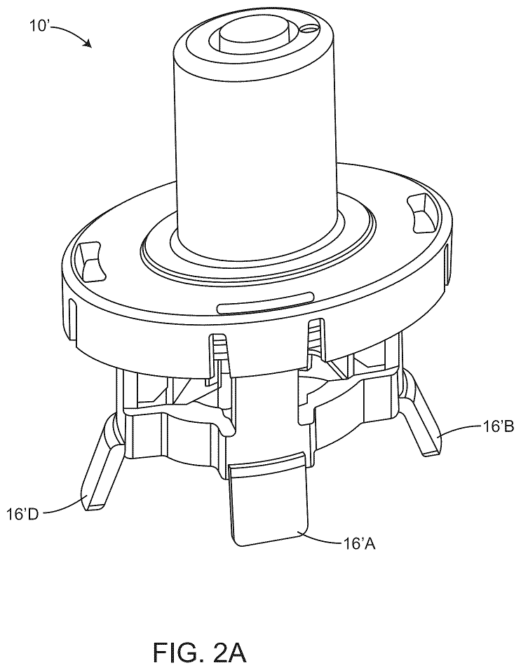

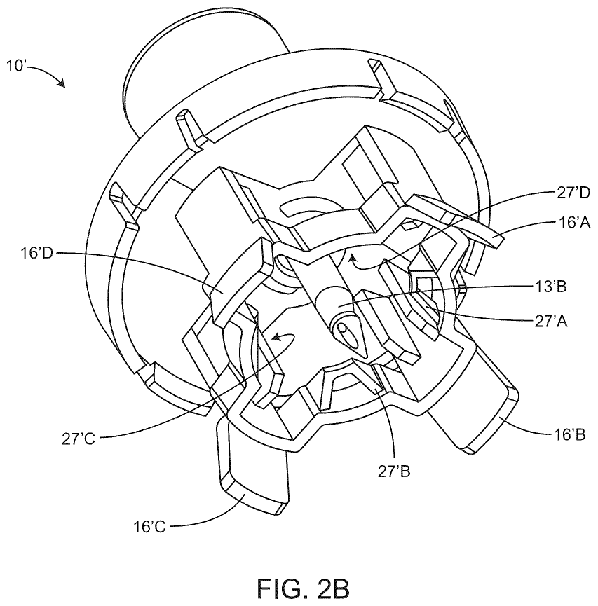

FIGS. 2A and 2B illustrate an adaptor 10′ according to another example of the presently disclosed subject matter. It is to be understood herein that the adaptor 10′ is identical to the adaptor 10 and can include all the features thereof, with the only differences being in the shape of the distal ends 16′A, 16′B, 16′C, and 16′D, the guiding elements 27′A, 27′B, 27′C, and 27′D, and spike 13′. The guiding elements 27′A, 27′B, 27′C, and 27′D although being configured to operate in the similar manner as the guiding elements 27A, 27B, 27C, and 27D, have a different shape and structure. For instance, as compared to the guiding elements 27A, 27B, 27C, and 27D being single elements positioned at the center of the central portions 23A, 23B, 23C, and 23D, the guiding elements 27′A, 27′B, 27′C, and 27′D include two parts each extending from the parts of the central portions adjacent the respective reformable portions.

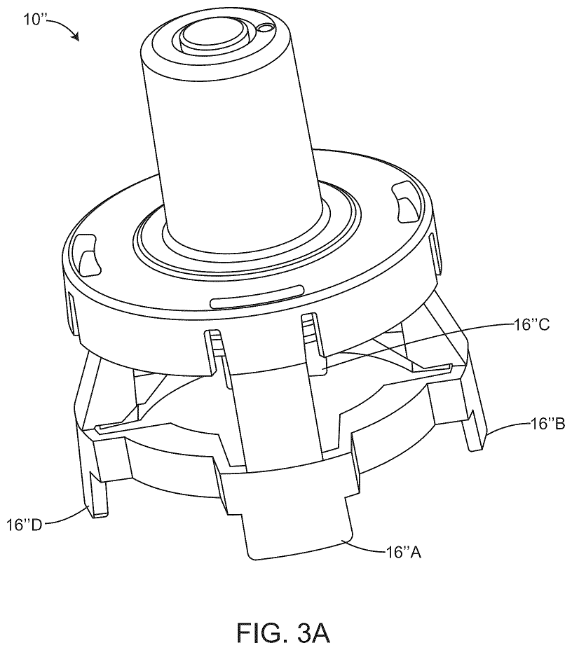

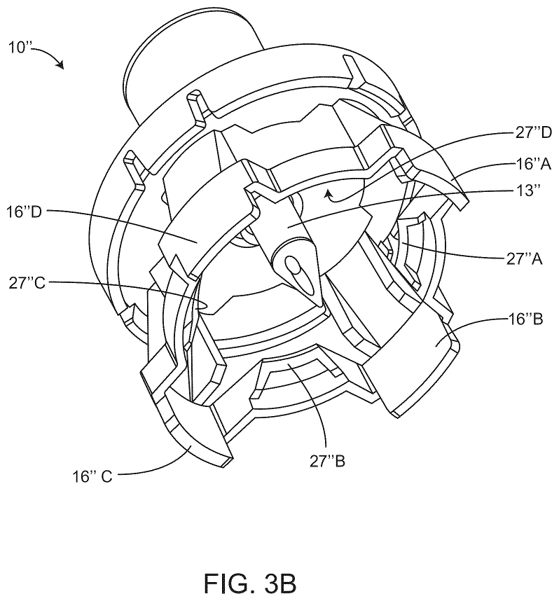

FIGS. 3A and 3B illustrate an adaptor 10″ according to another example of the presently disclosed subject matter. It is to be understood herein that the adaptor 10″ is identical to the adaptor 10 and can include all the features thereof, with the only differences being in the shape of the distal ends 16″A, 16″B, 16″C, and 16″D, the guiding elements 27″A, 27″B, 27″C, and 27″D, and spike 13″. The guiding elements 27″A, 27″B, 27″C, and 27″D although being configured to operate in the similar manner as the guiding elements 27A, 27B, 27C, and 27D, are shaped and structured similar to those of the guiding elements 27′A, 27′B, 27′C, and 27′D of the adaptor 10′.

While various inventive examples have been described and illustrated herein, those of ordinary skill in the art will readily envision a variety of other means, materials, or structure for performing the function, obtaining the results, or one or more of the advantages described herein, and each of such variations or modifications is deemed to be within the scope of the inventive examples described herein. More generally, those skilled in the art will readily appreciate that all parameters, dimensions, materials, and configurations described herein are meant to be for example only and that the actual parameters, dimensions, materials, and configurations will depend upon the specific application or applications for which the inventive teachings is/are used. Those skilled in the art will recognize or be able to ascertain using no more than routine experimentation, many equivalents to the specific inventive examples described herein. It is, therefore, to be understood that the foregoing examples are presented by way of example only and that, within the scope of the appended claims, equivalents thereto, and any claims supported by the present disclosure, inventive examples may be practiced otherwise than as specifically described and claimed. Inventive examples of the present disclosure are directed to each individual feature, system, article, material, composition, kit, method, and step, described herein. In addition, any combination of two or more such features, systems, articles, materials, compositions, kits, methods, and steps, if such features, systems, articles, materials, compositions, kits, methods, and steps, are not mutually inconsistent, is included within the inventive scope of the present disclosure.

Examples disclosed herein may also be combined with one or more features, functionality, or materials, as well as complete systems, devices or methods, to yield yet other examples and inventions. Moreover, some examples, may be distinguishable from the prior art by specifically lacking one and/or another feature disclosed in the particular prior art reference(s); i.e., claims to some examples may be distinguishable from the prior art by including one or more negative limitations.

Also, as noted, various inventive concepts may be embodied as one or more methods, of which an example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one example, to A only (optionally including elements other than B); in another example, to B only (optionally including elements other than A); in yet another example, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Although various example embodiments have been described in detail herein, however, in view of the present disclosure many modifications are possible in the example embodiments without materially departing from the concepts of present disclosure. Accordingly, any such modifications are intended to be included in the scope of this disclosure. Likewise, while the disclosure herein contains many specific combinations, these specific combinations should not be construed as limiting the scope of the disclosure or of any of the appended claims, but are provided as a description pertinent to one or more specific embodiments that may fall within the scope of the disclosure and the appended claims. Any described features from the various embodiments disclosed may be employed in combination with other disclosed embodiments. In addition, other embodiments of the present disclosure may also be devised which lie within the scopes of the disclosure and the appended claims.

This disclosure provides various examples, embodiments, and features which, unless expressly stated or which would be mutually exclusive, should be understood to be combinable with other examples, embodiments, or features described herein.

1-21. (canceled)

22. An adaptor configured to be connected to a first container of a fluid transfer system and to facilitate fluid communication therethrough between the first container and a second container of the fluid transfer system, said adaptor comprising:
a proximal body portion; and
a distal body portion extending distally from the proximal body portion at least partially along a longitudinal axis of the adaptor, said distal body portion comprising:
a plurality of circumferential elements each extending distally with respect to the proximal body portion, each of the plurality of circumferential elements comprising a respective bridge portion; and
a plurality of connection elements each connecting the bridge portions of corresponding two adjacent circumferential elements of the plurality of circumferential elements, each of the plurality of connection elements being configured to radially displace between a normal state and an expanded state in a connection plane perpendicular to the longitudinal axis for facilitating the connection of the adaptor to the first container in said connection plane, each of the plurality of connection elements comprising a connection surface extending in the connection plane and configured to engage a corresponding engagement portion of the first container, wherein the connection surface extends within the connection plane at the normal state as well as the expanded state of the connection element.

23. The adaptor according to claim 22, wherein the connection surface has an innermost portion closest to the longitudinal axis, said innermost portion being configured to be at a first distance from the longitudinal axis at the normal state of the corresponding connection elements and at a second distance greater than the first distance at the expanded state of the corresponding connection elements.

24. The adaptor according to claim 23, wherein the innermost portions of the connection surfaces define portions of a virtual circle extending in the connection plane, wherein the virtual circle has a first diameter at the normal state of the connection elements and a second diameter greater than the first diameter at the expanded state of the connection elements.

25. The adaptor according to claim 22, wherein the connection elements are configured to radially displace from the normal state to the expanded state in response to an axial force applied on the connection elements in a direction from the distal body portion to the proximal body portion along the longitudinal axis.

26. The adaptor according to claim 25, wherein the axial force is a pushing force applied by the first container during said connection of the adaptor to the first container.

27. The adaptor according to claim 25, wherein the connection elements are configured to radially displace elastically from the expanded state to the normal state upon removal of said axial force.

28. The adaptor according to claim 22, wherein the bridge portions extend at least partially in the connection plane.

29. The adaptor according to claim 22, wherein each of the connection elements comprises at least one reformable portion configured to reform for facilitating the displacement of the connection elements between the normal state and the expanded state.

30. The adaptor according to claim 29, wherein each of the connection elements has a central portion and two reformable portions connected to corresponding bridge portions.

31. The adaptor according to claim 30 wherein the connection surface constitutes at least a part of the central portion.

32. The adaptor according to claim 22, wherein each of the plurality of the connection elements comprises an innermost portion closest to the longitudinal axis, and a guiding element extending distally from the innermost portion in a direction along the longitudinal axis as well as in a direction away from the longitudinal axis, wherein the guiding element is configured to engage the first container during the connection of the adaptor with the first container.

33. The adaptor according to claim 32, wherein the guiding element is configured to translate an axial force, applied by a head of the first container thereon in a direction from the distal body portion to the proximal body portion along the longitudinal axis during said connection, to a radial force in a direction along the connection plane away from the longitudinal axis.

34. The adaptor according to claim 33, wherein the radial force causes the connection elements to move away from the longitudinal axis in the connection plane, and displace into the expanded state, thereby creating a space for the head of the first container to extend beyond the connection elements.

35. The adaptor according to claim 34, wherein the connection elements are configured to elastically displace into the normal state once the head of the first container extends beyond the connection elements, thereby gripping a neck portion of the first container to effect the connection between the adaptor and the first container in the connection plane.

36. The adaptor according to claim 22, wherein each of the connection elements comprise a respective side surface extending in a direction parallel to the longitudinal axis, the side surface defining a height of the connection element in the direction parallel to the longitudinal axis.

37. The adaptor according to claim 36, wherein each of the bridge portions has a dimension parallel to and corresponding to the height of the connection elements.

38. The adaptor according to claim 37, wherein the connection elements are connected to the respective bridge portions along the entire height of the connection elements.
